(19) United States
(12) Patent Application Publication
(10) Pub. No.: US 2016/0067787 A1
(43) Pub. Date: Mar. 10, 2016

(54) MACHINE TOOL HAVING ANTI-VIBRATION TUNING MECHANISM FOR CHATTER MINIMIZED MACHINING

(71) Applicant: ENRICO R. GIANNETTI, East Bernard, TX (US)

(72) Inventor: ENRICO R. GIANNETTI, East Bernard, TX (US)

(21) Appl. No.: 14/481,758

(22) Filed: Sep. 9, 2014

(51) Int. Cl. B23B 29/12; G01M 1/02

(52) U.S. Cl. CPC B23B 29/12; G01M 1/02; B23B 2250/16; B23B 2250/04; B23B 2250/12; B23B 2260/004

(57) ABSTRACT

A vibration dampening through coolant tool holder, such as a boring bar, for machining operations, has an internal chamber within which a vibration dampening mass is supported at each axial end by resilient buffer members. A vibration adjusting piston is linearly moveable with the tool holder and has dampening adjustment engagement with the mass. A dampening adjustment mechanism causes linear movement of the piston and applies controlled force of the piston to the mass and has a micrometer type rotary adjustment member that imparts linear force to the piston. The linear piston adjustment can also have a worm gear drive mechanism for controlling linear piston movement.

### BACKGROUND OF THE INVENTION

1. Field of the Invention

The present invention relates generally to machine tools or tool holders for metal cutting and working machines. More particularly the present invention concerns tool holders including boring bars, threading tools and the like, which because of their length and flexibility are often subject to significant vibration during rotary machining operations. This invention also concerns machine tools that have a through-coolant capability for conducting a flow of pressurized coolant fluid through internal passages of a machine tool and emitting the coolant as a jet or spray that is directed to the cutting interface of a cutting insert with rotating metal stock for cooling and for removal of metal chips that have been cut from the rotating stock.

2. Description of the Prior Art

Machining vibration, typically referred to as “chatter”, especially when relatively long and somewhat flexible machine tools such as boring bars are used, interferes with optimum machining activity and usually results in roughly machined surfaces and noisy machining operations when machining internal and external surfaces, threads and the like within or on metal stock that is rotated by a machining system. Numerous attempts have been made over an extensive period of time to achieve tuning of boring bars and other such machine tools to cancel the resonant frequency of the machine tools and thus minimize the vibration or chatter that interferes with optimum metal cutting operations such as boring, threading and cutting.

Tool holders such as boring bars have been developed, as set forth in U.S. Pat. No. 3,774,730, that incorporate a dynamic vibration absorber having the capability for being dynamically tuned to dampen the rotary machining vibration that causes tool chatter resulting in rough and noisy machining during rotary metal working activity. U.S. Pat. No. 6,443,673 discloses a tunable tool holder has an absorber mass that is supported within a vibration dampening chamber between elastomer supports and employs a moveable and adjustable pressure plate for compressing the elastomer supports and dynamically tuning the tool holder to minimize the vibration or chatter that occurs during machining activity.

### SUMMARY OF THE INVENTION

It is a principal feature of the present invention to provide a novel machine tool for supporting a replaceable cutter and having the capability of being tuned by adjustment to minimize tool chatter during machining;

It is another feature of the present invention to provide a novel machine tool having an internal vibration absorbing mass for minimizing the presence of tool chatter or vibration during machining and having a tuning mechanism that is selectively adjustable by a machinist to essentially absorb or cancel the resonant frequency of the tool as needed to provide for smooth and efficient cutting of precision metal surfaces on a rotating work-piece.

It is another feature of the present invention of provide a novel vibration adjustable machine tool having an internal fluid flow passage through which coolant fluid is pumped through the machine tool and is emitted as a jet from a jet port in a cutter support head and is applied to the cutting interface of the replaceable cutter member with the work-piece being machined.

Briefly, the various objects and features of the present invention are realized through the provision of an elongate machine tool holder mechanism having a cutter support head to which a replaceable cutter insert is secured for machining. The machine tool defines an elongate internal chamber within which is located a vibration absorbing mass that is preferably composed of a dense material, such a carbide, or any other material having a density exceeding that of steel. The vibration absorbing mass is supported within the elongate internal chamber by annular vibration dampening members that are positioned about reduced diameter end portions of the vibration absorbing mass so that the mass is supported in spaced relation with internal surfaces of the elongate internal chamber and internal components of the machine tool.

According to an embodiment of the present invention a worm gear driven vibration tuning mechanism is provided within the machine tool, and permits worm gear actuated rotation and linear movement of a force applying piston member, permitting a force adjustment to be directed toward or away from the vibration absorbing mass for efficient tuning of the vibration dampening characteristics of the vibration absorbing mass.

According to another embodiment of the present invention a machine tool holder, such as a boring bar, internal threading tool, internal grooving tool or the like is provided with an anti-vibration tuning mechanism in the general form of a micrometer type rotary adjustment mechanism that is manually operated from the rear end portion of an elongate machine tool holder. The micrometer type rotary adjustment mechanism is rotated in either selected rotational direction to cause inward or outward linear movement of a force applying vibration tuning piston member. This inward or outward linear piston movement alters the vibration adjusting force that is applied by the tuning piston to the rearmost elastomer dampening ring for anti-vibration adjustment or tuning to substantially eliminate machine tool vibration and chattering during machining.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is an isometric illustration, shown in partial section, illustrating a machine tool holder in the form of a through-coolant boring bar that embodies the principles of the present invention;

FIG. 2 is a longitudinal section view showing the through-coolant machine tool holder of FIG. 1, showing the internal components thereof in detail;

FIG. 3 is an enlarged partial longitudinal sectional view showing the anti-vibration tuning mechanism in greater detail an intermediate section of the through-coolant

FIG. 4 is an end elevation view showing the left end of the through-coolant machine tool holder of FIG. 2;

FIG. 5 is a partial longitudinal section view showing part of the tuning adjustment mechanism of the through-coolant machine tool holder of FIG. 2;

FIG. 6 is a transverse section view taken along line 5-5 of FIG. 4

FIG. 7 is a longitudinal section view with parts thereof cut away and showing an anti-vibration mass and its adjustment mechanism;

FIG. 8 is a transverse section view taken along line 7-7 of FIG. 6;

FIG. 9 is an exploded end view and operational illustration showing assembly of the anti-vibration tuning mechanism of the machine tool holder;

FIG. 10 is another operational illustration similar to that of FIG. 8

FIG. 11 is an isometric operational illustration of the mechanical anti-vibration tuning mechanism showing outward linear motion of a central adjustment member in response to rotary motion of an annular driven sleeve member;

FIG. 12 is an isometric operational illustration of the mechanical anti-vibration tuning mechanism showing inward linear movement of a central tuning adjustment member in response to rotary motion of an annular driven force applying member; and

FIG. 13 is an isometric illustration in longitudinal section showing the through-coolant flow system of the anti-vibration machine tool holder of the present invention;

FIG. 14 is a longitudinal section view showing an adjustable through coolant and anti-vibration tool holder having micrometer type anti-vibration adjustment and embodying the principles of the present invention;

FIG. 15 is another longitudinal section view showing an adjustable through coolant and anti-vibration tool holder having a micrometer type anti-vibration adjustment mechanism;

FIG. 16 is a longitudinal section view showing an adjustable through coolant and anti-vibration tool holder having micrometer type anti-vibration adjustment and having a side entry coolant fluid supply;

FIG. 17 is a longitudinal section view showing an adjustable through coolant and anti-vibration tool holder having micrometer type anti-vibration adjustment

FIG. 18 is a top view of an adjustable anti-vibration tool holder having an externally mounted coolant fluid receiving and distributing mechanism directing one or more jets of coolant fluid to the metal cutting insert of the tool holder;

FIG. 19 is a section view taken along line 19-19 of FIG. 18;

FIG. 20 is a longitudinal section view showing an adjustable through coolant and anti-vibration tool holder having micrometer type anti-vibration adjustment and having a side mounted coolant entry fitting;

FIG. 21 is a longitudinal section view showing a through coolant and anti-vibration tool holder having a tuning piston and a releasable lock member securing the tuning piston against rotational movement;

FIG. 22 is a partial longitudinal section view showing the tuning features for controlling anti-vibration dampening adjustment;

FIG. 23 is a partial longitudinal section view of a tool holder mechanism emphasizing coolant flow control options;

FIG. 24 is an end elevation view of the tool holder mechanism of FIG. 23; and

FIG. 25 is a partial longitudinal section view of a through-coolant anti-vibration tool holder of the present invention having a manually actuated hex drive mechanism for anti-vibration dampening or tuning adjustment of the tool holder;

### DETAILED DESCRIPTION OF PREFERRED EMBODIMENT

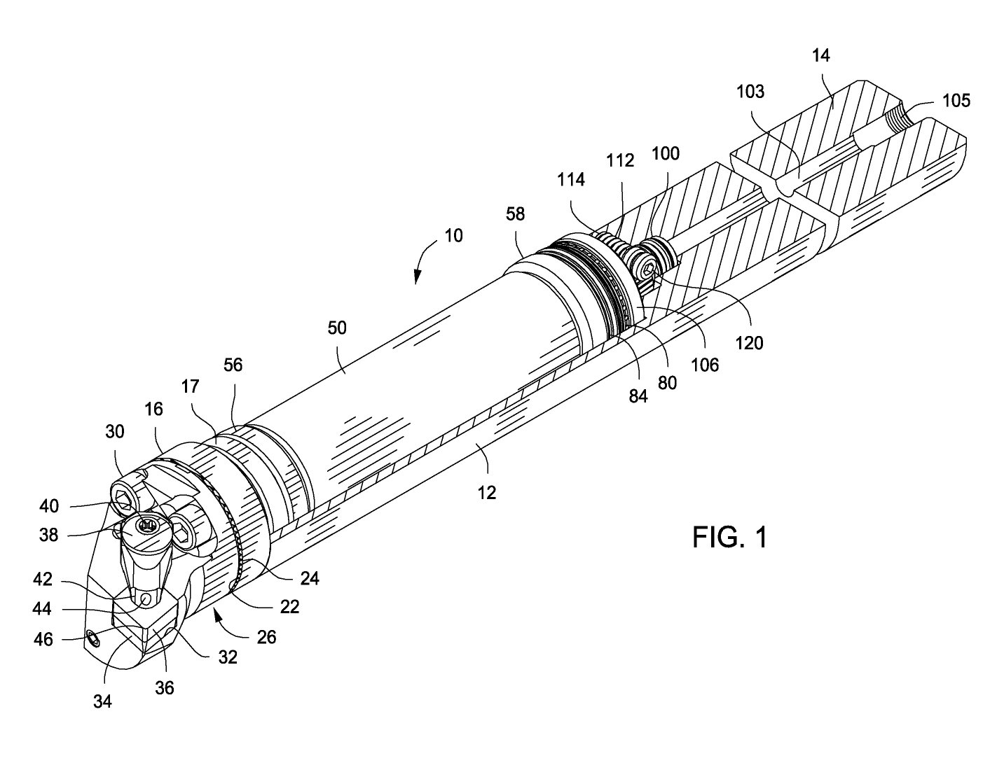

Referring now to the drawings and first to the partial longitudinal section view of FIG. 1, an anti-vibration adjustable machine tool holder embodying the principles of the present invention is shown generally at 10 and is in the form of a boring bar that is intended to be used to cut cylindrical internal surfaces within a work-piece being machined. The machine tool holder incorporates an adjustable or tunable anti-vibration or anti-chatter machining adjustment mechanism that can be manually adjusted to substantially eliminate the tool holder vibration that is responsible for rough machining of cylindrical surfaces.

Though the through-coolant capability of the tool holder is not necessary for anti-vibration tuning or adjustment, the machine tool holder preferably provides a coolant handling system to facilitate efficiency of handling and machining. The machine tool holder has an elongate tool body or tool shank 12 having a rear end portion 14 that is adapted to be retained by a machining system and has a tool support collar 16 having an externally threaded projection 17 that is threaded to the internally threaded end 18 of an intermediate tubular section 20. The tool support collar 16 defines a grooved face 22 that is engaged by a corresponding grooved face 24 of a tool support head shown generally at 26 and has a plurality of internally threaded openings 28 that receive threaded fasteners 30 and secure the tool support head in immoveable relation with the tool support collar 16 of the elongate tool body 12.

The tool support head 26 defines a cutter insert seat 32 on which is seated a cutter support member 34 that provides for support and stability of a replaceable cutter insert 36. An insert clamp member 38 is retained in assembly with the tool support head 26 by a retainer such as a clamp screw 40. The insert clamp member 38 has a clamping portion 42 that engages the replaceable cutter insert 36 and secures it against movement during machining activity. The insert clamp member 38 also defines a coolant jet port 44 from which a jet of pressurized coolant fluid, passing through-coolant passages of the tool holder, is directed to the cutting edge 46 of the replaceable cutter insert 36 for cooling of the cutting interface of the cutter insert with the work piece being rotated for machining.

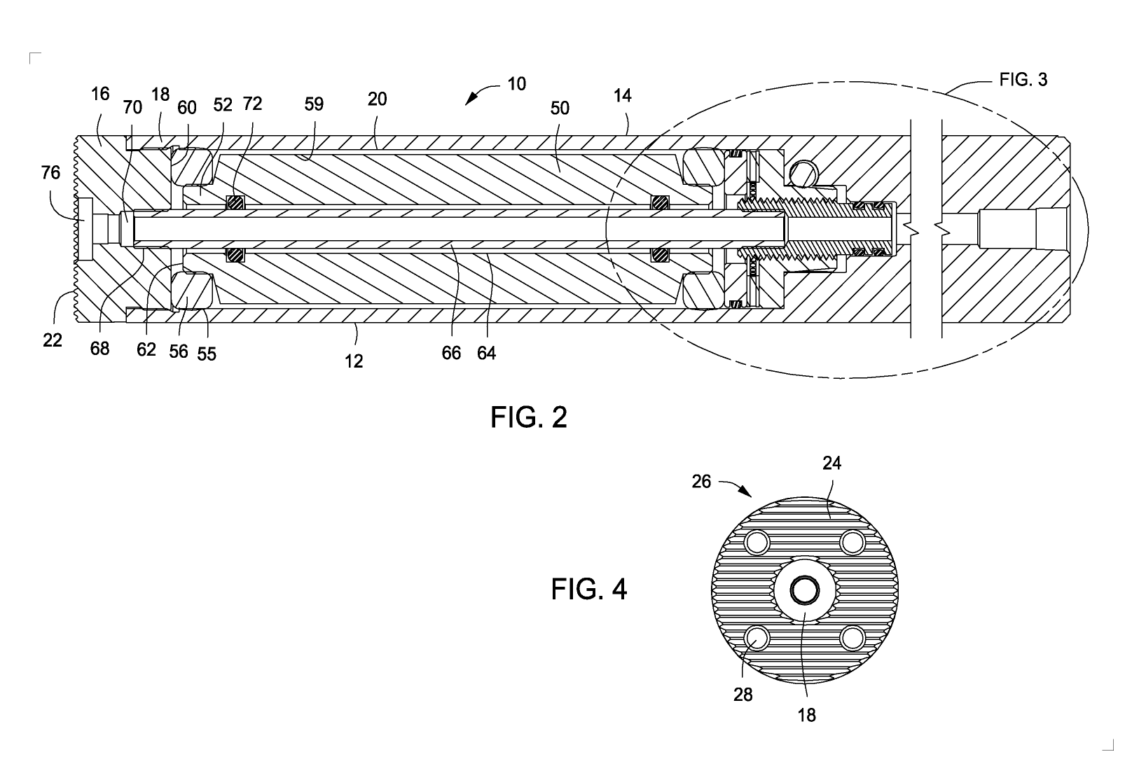

As best shown in the longitudinal section view of FIG. 2, the intermediate tubular section 20 of the elongate tool body 12 is of tubular configuration, defining an elongate chamber 48 within which is located an anti-vibration mass 50. The anti-vibration mass 50 is preferably composed of a dense and heavy material such as carbide or any other material having a density exceeding the density of steel. The anti-vibration mass 50 has reduced diameter axial end sections 52 and 54 about which are located dampening ring members 56 and 58. The dampening ring members are composed of an elastomeric material such as rubber, elastic polymer material or any other suitable material having elastomeric qualities. The dampening ring members define outer peripheral surfaces 55 and 57 that engage the internal cylindrical surface 59 of the elongate tool body 12 and support the anti-vibration mass 50 with its outer peripheral surface in spaced relation with the inner surface 59 of the elongate tool body 12.

The tool support collar 16 defines a generally planar support surface 60 that is engaged by the dampening ring member 56. The dampening ring member 56 is of sufficient dimension to ensure that the end surface 62 of the anti-vibration mass 50 is maintained in spaced relation with the planar support surface 60 of the tool support collar 16. At the opposite end portion of the anti-vibration mass 50, the dampening ring member 58 is also of sufficient axial dimension that it maintains the axial end section 54 of the anti-vibration mass 50 separate from contact with any internal structural member of the machine tool.

As also shown best in FIG. 2, the anti-vibration mass 50 defines a central coolant passage 64 that extends axially therethrough. A coolant tube 66 is located within the central coolant passage and has a threaded end section 68 that is threaded within a coolant tube receptacle 70 of the tool support collar 16. Annular seal members, such as O-ring seals 72 and 74 are retained within axially spaced internal seal grooves of the anti-vibration mass 50 and have sealing engagement with the outer cylindrical surface of the coolant tube 66 and establish sealing between the coolant tube and the anti-vibration mass 50. The tool support collar 16 defines an annular seal seat 76 that cooperates with a corresponding annular seal seat 78 of the tool support head 26 to define an annular seal pocket within which an elastomer seal member will be retained to maintain a fluid tight seal at the connection interface of the tool support head with the tool support collar 16.

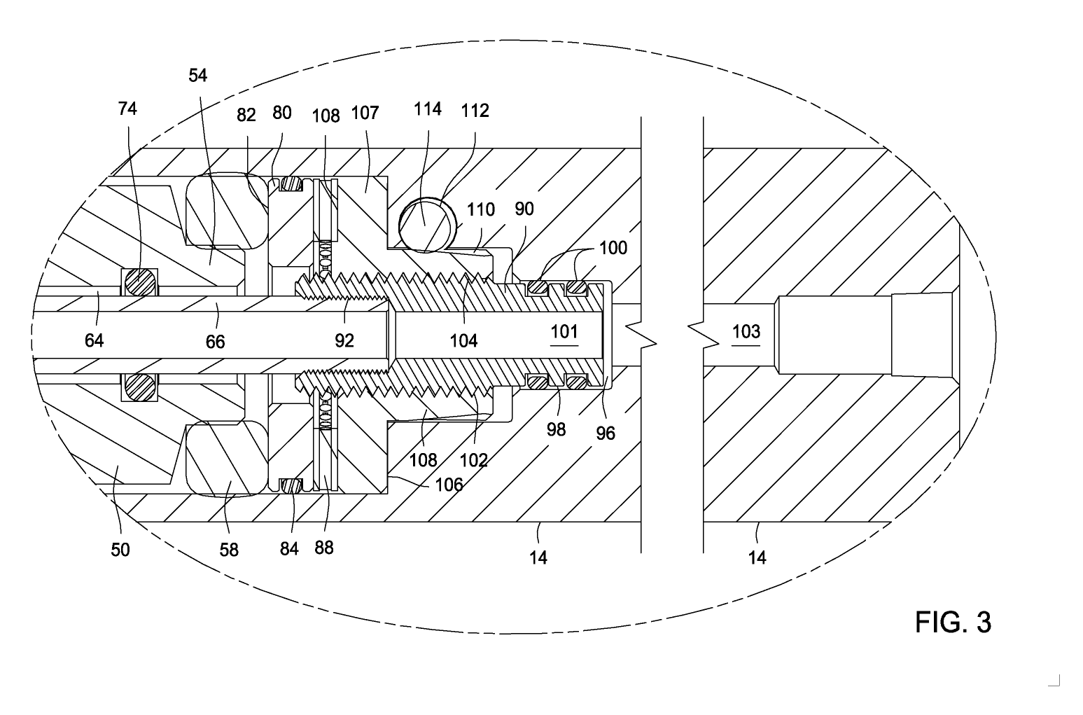

As shown in FIG. 2 and in greater detail in the partial longitudinal section view of FIG. 3, a slip disc member 80 is located within the elongate chamber 48 and defines a generally planar thrust surface 82 that is in thrust transmitting engagement with the dampening ring member 58. The slip disc member 80 also defines a central opening 81 through which the coolant tube 66 extends. An annular sealing member 84, such as an O-ring seal, is contained within an annular seal groove of the slip disc member 80. The slip disc member further defines a generally planar bearing support surface 86 which is engaged by a thrust bearing 88.

An externally threaded shaft member 90 is threaded or otherwise mounted to the end portion 92 of the coolant tube 66 and defines an end section 94 that constitutes a sealing end that is received within a sealing receptacle 96 of the elongate tool body 12. The sealing receptacle 96 is defined in part by a cylindrical sealing surface 98 that is engaged by annular seal members 100 that are maintained within annular internal seal grooves of the drive end member 94. The annular seal members maintain sealing between the drive end member and the elongate tool body 12 during linear movement of the drive end member. The externally threaded shaft member 90 defines an internal longitudinal flow passage 101 that is disposed in fluid communication with a centrally located flow passage 103 extending though the elongate tool body or tool shank 12 from its rear or mounting end portion 14. The outer extent of the flow passage 103 defines an internally threaded section 105 within which the coupling of a coolant supply tube is connected for the conduct of coolant fluid from a coolant pump of the machining system through the elongate tool body and adjustable or tuneable anti-vibration mechanism to the coolant jet port 44 of the cutter support head 26.

The drive end member is provided with external threads 102 that are engaged within the internal drive threads 104 of a rotary force transmitting member 106. The rotary force transmitting member 106 has a bearing engagement flange 107 having a planar force transmitting surface 108 that is disposed in engagement with the thrust bearing member 88. Rotary force transmitting member 106 has a generally cylindrical hub member 109 that has an external worm gear 110 that is engaged by the external worm gear 112 of a rotary worm member 114. Upon rotation of the worm member 114 in either rotary direction the engaged worm gears 110 and 112 cause rotation of the force transmitting member 106, thus causing the engaged threads 102 and 104 to cause linear motion for the force transmitting member either toward the anti-vibration mass 50 or away from the anti-vibration mass 50, depending on the direction of rotation of the worm member 114. The worm member, as shown in FIG. 6 is located within a worm passage 116 of the elongate tool body or tool shank 12 and is secured against separation from the worm passage by a worm stop member 118. The worm member 114 defines a worm drive receptacle 120, such as a hex or Torx drive receptacle, thus permitting manual rotation of the worm member by an Allen wrench or any other type of manually operable tool having a hex drive, Torx drive or any suitable worm drive member.

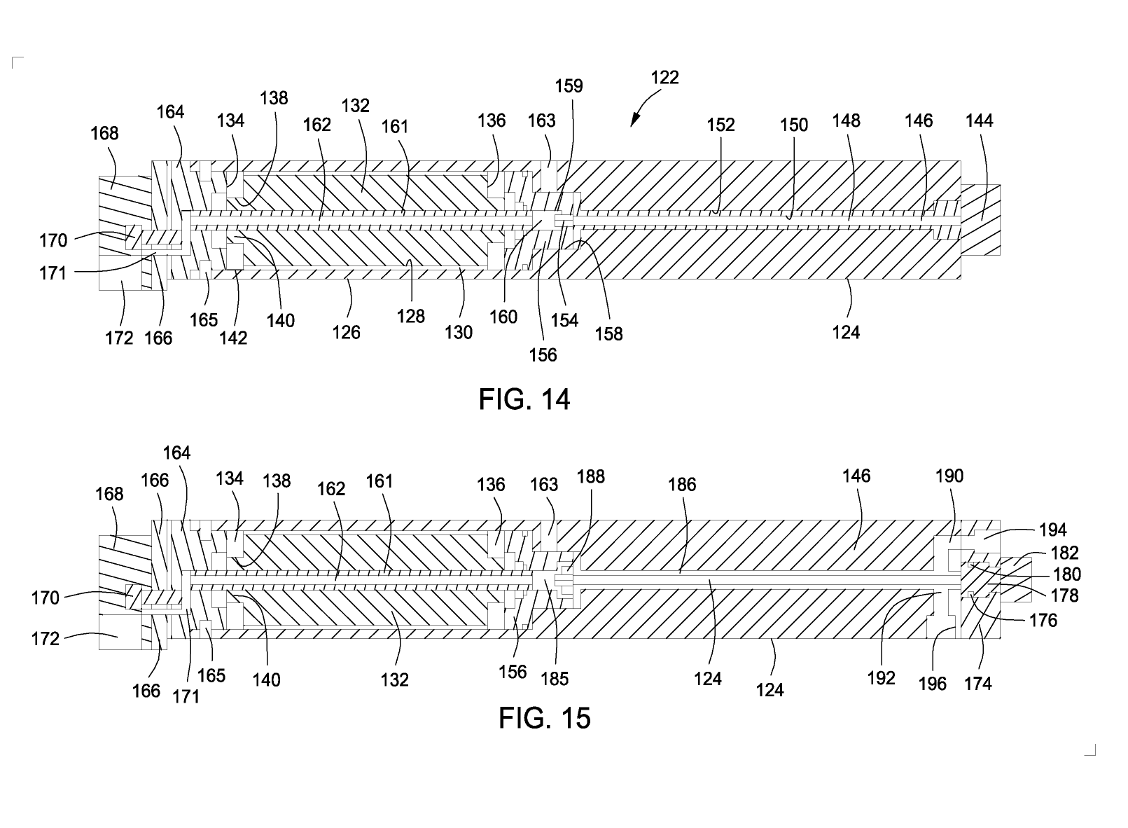

Referring now to FIGS. 14-19, it is considered desirable to provide a tool holder of considerable length, such as a boring bar for example, that may have a relatively small cross-section, such that it would be likely to vibrate or chatter due to the flexibility of the tool holder as machining operations are being conducted. To substantially minimize or eliminate the potential for vibration or chatter during machining, a tool holder shown generally at 122 having an elongate tool shank 124 that is designed to be received by a chuck member of a machine tool or machining system.

The elongate tool shank 124 has an intermediate tubular section 126 having an internal wall surface 128 that defines a compartment 130 within which is located an anti-vibration mass 132. The anti-vibration mass 132 is supported within the compartment 130 by means of resilient support members 134 and 136 each having inner circular support surfaces 138 that are received by the circular shoulders that are defined by axial projections 140 of the anti-vibration mass 132. External circular support surfaces 142 of the resilient support members each have supported engagement with the internal wall surface 128 of the elongate tool shank 124, thereby suspending the anti-vibration mass 132 for limited vibration dampening movement within the compartment 130.

For tuning adjustment of the anti-vibration mass 132, according to FIGS. 14-19, the tool holder 122 is provided with a micrometer type anti-vibration adjustment mechanism that is manually operated by rotation of an externally knurled adjustment member 144 that is located at the rear end portion 146 of the elongate tool shank 124 as shown in FIG. 14. An adjustment shaft 148, also referred to as a wrench shaft, is mounted in non-rotatable fashion to the rotary adjustment member 144 and extends through a centrally located shaft bore 150. The shaft bore 150 is of larger internal dimension than the external dimension of the adjustment shaft 148, thus defining an annulus 152 about the shaft that serves as a coolant fluid flow passage. The adjustment shaft or wrench shaft 148 defines a non-circular drive extremity 154 that is engaged within a corresponding non-circular drive opening of a force transmitting member 156 that has threaded engagement within an internally threaded receptacle 158 of the force transmitting member. Rotation of the adjustment shaft causes corresponding rotation of the force transmitting member 156, which drives the force transmitting member 156 toward or away from the anti-vibration mass 132, depending on the direction of rotation.

A fluid flow channel 159 establishes fluid communication of the annulus flow passage 152 with a fluid passage 160 within the force transmitting member 156. A tubular fluid conductor member 161 having an end portion located within a central tube receptacle of the force transmitting member defines a fluid flow passage 162 through the anti-vibration mass 132. A collar member 164 is connected with the forward end portion of the elongate tool shank 124 by a plurality of dowel pins 165. The collar member defines a grooved face similar to that shown at 24 is FIGS. 1 and 4 to provide for stability of a cutter support head 166 of the nature that is shown generally at 26 in FIG. 1. An insert support head 168 is secured in assembly with the tool support head and collar 164 by means of one or more retainer screws 170. The cutter support head 168 defines a fluid flow passage 171 that terminates at a cutter support seat 172 to permit one or more jets of coolant fluid to be directed to the cutting edge of a metal cutting insert that is releasably mounted to the cutter support seat.

The anti-vibration machine tool holder of FIG. 15 is quite similar to the tool holder that is shown in FIG. 14, the principal differences being an anti-vibration mass adjustment section at the supported end portion of the tool holder shank 146 and the coolant flow passage arrangement within the tool holder shank. In FIG. 15 the chuck supported end of the shank 146 is provided with an adjustment end member 174 having an adjustment receptacle 176 within which is rotatably positioned an adjustment member 178. The adjustment member is sealed with respect to the inner wall surface of the adjustment receptacle by an O-ring seal 180 to prevent coolant leakage. A micrometer type adjustment member 182, which may be externally knurled to facilitate ease of manual rotation for anti-vibration adjustment, is connected with or an integral part of the adjustment member 178. In similar manner as shown in FIG. 14, an adjustment shaft or wrench shaft 184 extends through a central passage 186 and causes rotation of a drive member 188 that causes linear movement of a force transmitting member 156 that has force transmitting engagement with the resilient support member 136. Manual rotation of the micrometer adjustment member 182 in either rotational direction causes adjustment of the anti-vibration mass 132.

For coolant flow through the tool holder mechanism, the central passage 186 within the shank of the tool holder is of larger dimension than the dimension of the shaft 184, thus providing a flow passage annulus through which coolant fluid flows to an intermediate fluid chamber 185. A tubular member 161 is located centrally of the anti-vibration mass 132 and provides a passage 162 through which coolant fluid flows to a passage 171 for distribution to a coolant jet fitting that directs a jet of coolant fluid onto the cutting edge of a metal cutting insert that is mounted to the cutter support seat 172. Coolant passages 190 and 192 are provided in the tool shank 146 and in the adjustment end member 174 and have internally threaded inlets 194 and 196 that receive either a coolant connection fitting or a closure plug for coolant control or supply to the tool holder mechanism.

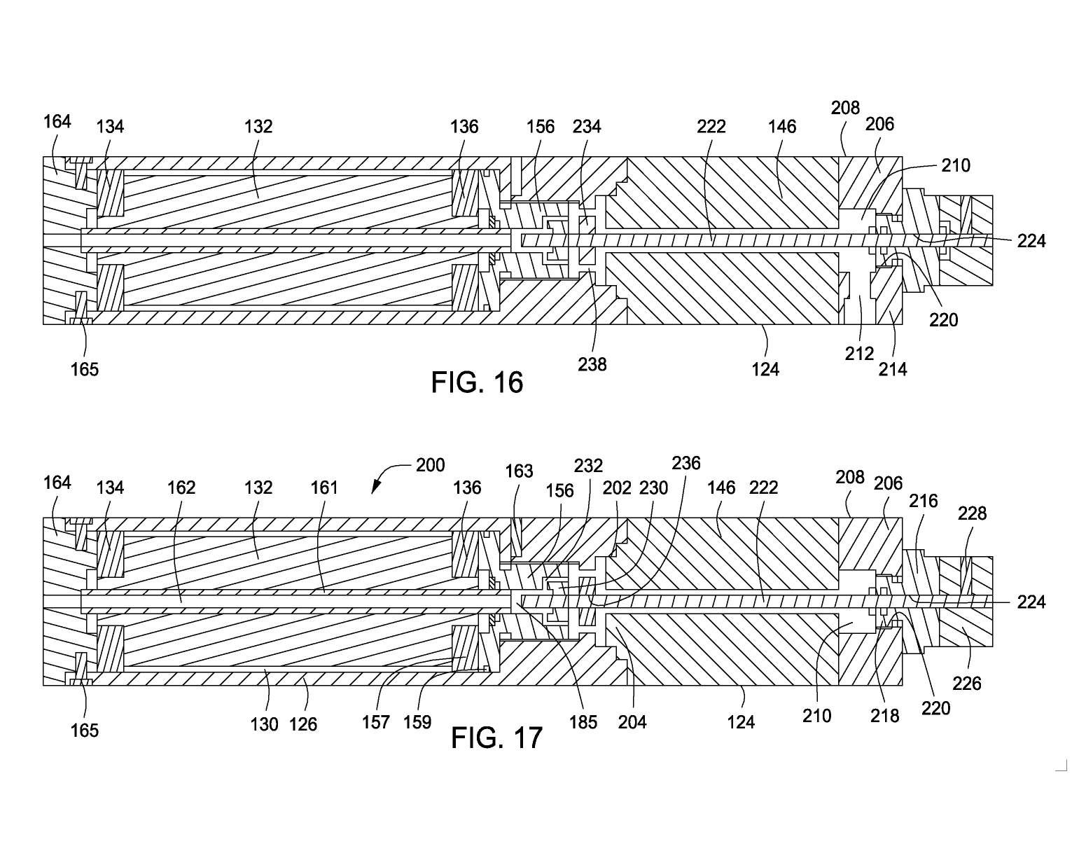

Referring now to FIGS. 16 and 17 another micrometer adjustment type anti-vibration tool holder, is shown generally at 200 which employs most of the features that have been previously discussed in connection with FIGS. 14 and 15. Like reference numerals have been used for identification of like parts and features. The force transmitting member 156 defines a flange portion 157 that engages the annular resilient support member for force transmission and carriers an external O-ring seal 159 to prevent leakage of coolant fluid from the coolant passage system into the compartment 130. A set screw 163 is threaded into the tubular body structure and serves to engage the force transmitting member 156 and lock it at any selected position within the compartment 130.

The rear end portion of the tubular body structure defines a receptacle within which a projection 204 of the tool holder shank 146 is received and retained. The assembly joint of the tubular body structure and the tool holder shank may be braised or welded or may be connected by threads to secure these components are disposed in immoveable assembly. Likewise, an anti-vibration housing section 206 is mounted to the rear end portion of the tool shank 146, also establishing a mounting joint 208 that may be braised, welded or threaded to establish an integral tool holder mechanism. The anti-vibration housing section 206 defines an internal coolant fluid compartment 210 and further defines a coolant inlet passage 212 having an internally threaded opening 214 within which an inlet fitting may be threaded to establish coolant fluid flow connection with a coolant supply conduit of the machining system to which the tool holder is mounted for machining operations.

An anti-vibration adjustment mount 216 has a mounting projection 218 that is secured and sealed within a mount receptacle 220 of the anti-vibration housing section 206. An anti-vibration adjustment shaft or wrench 222 extends through a central passage 224 of the anti-vibration housing section 206 and is secured in immoveable relation with a rotary adjustment member 226 by means of a retainer device 228 such as a set screw. The rotary adjustment member 226 is preferably in the form of a micrometer-like adjustment member and may be provided with indicia to ensure the rotary position of the adjustment member 226. An adjustment drive member 230 that is fixed to the vibration adjustment shaft or wrench 222 is positioned within a non-circular drive receptacle 232 and causes rotation of the force transmitting member 156 in response to rotation of the adjustment shaft or wrench 222.

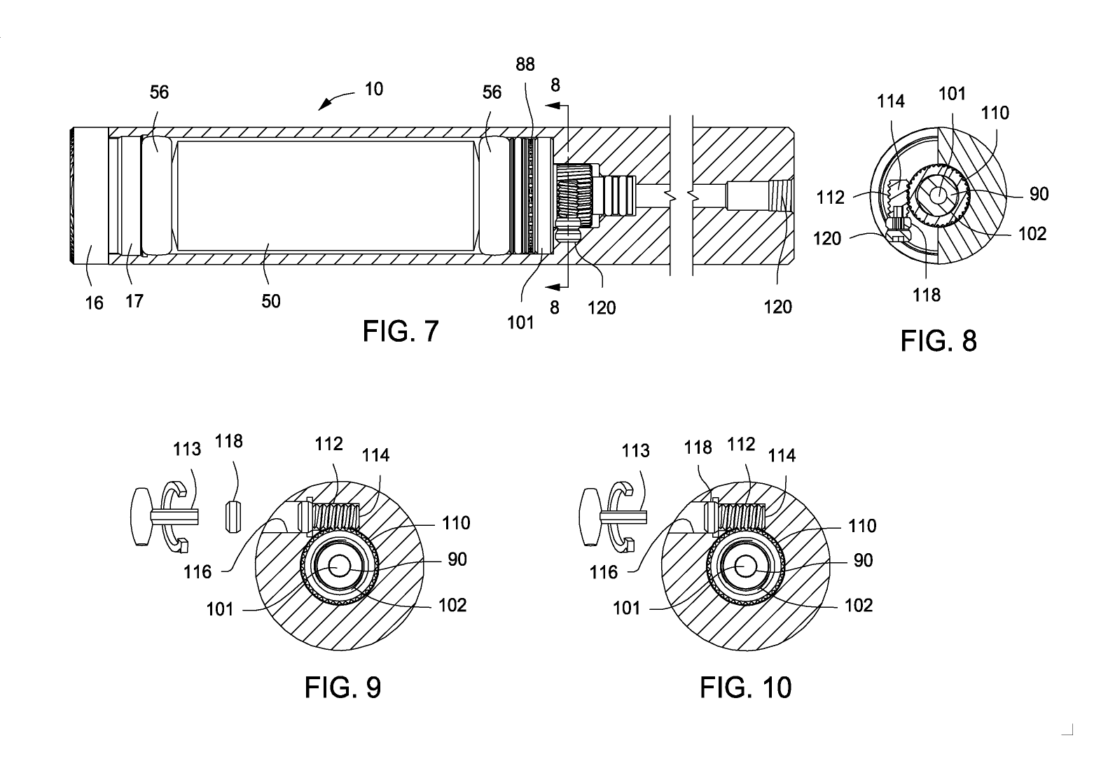

A structural member 234 that is integral with the intermediate tubular body section 126 has a central opening 236 that serves as a bushing for rotary stabilization of the forward end portion of the anti-vibration adjustment shaft or wrench 222. The structural member 234 defines multiple openings or slots 238 that define coolant fluid flow passages past the structural member. It should be borne in mind that the force transmitting member 156 may be moved linearly or may be moved linearly by threaded engagement as it is rotated by the anti-vibration adjustment drive member 230. If desired, a thrust bearing member may be interposed between the forwardly projecting flange 157 of the force transmitting member 156 and the resilient support member 136, such as is shown at 88 in FIG. 7.

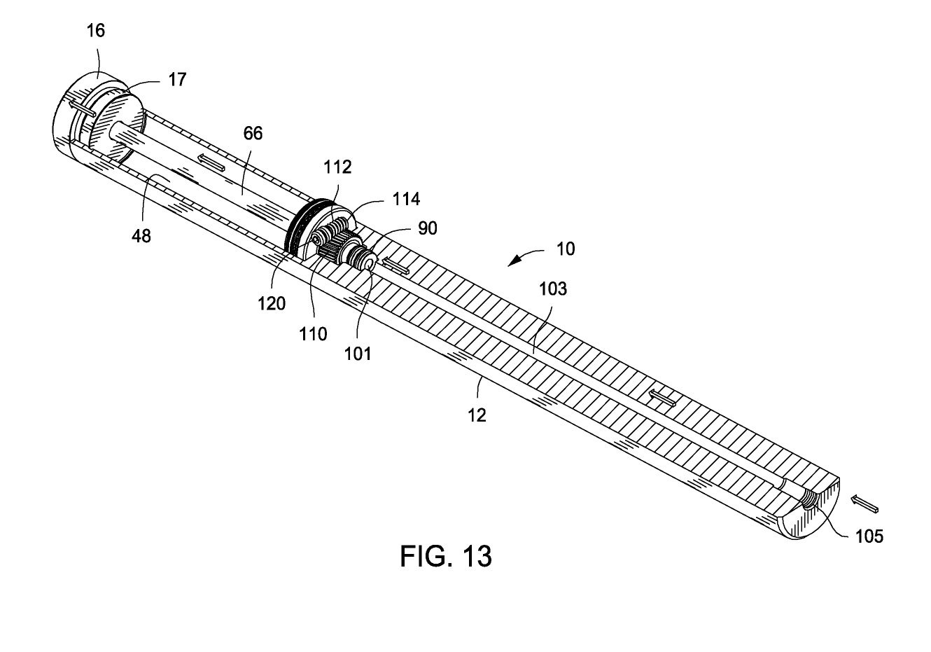

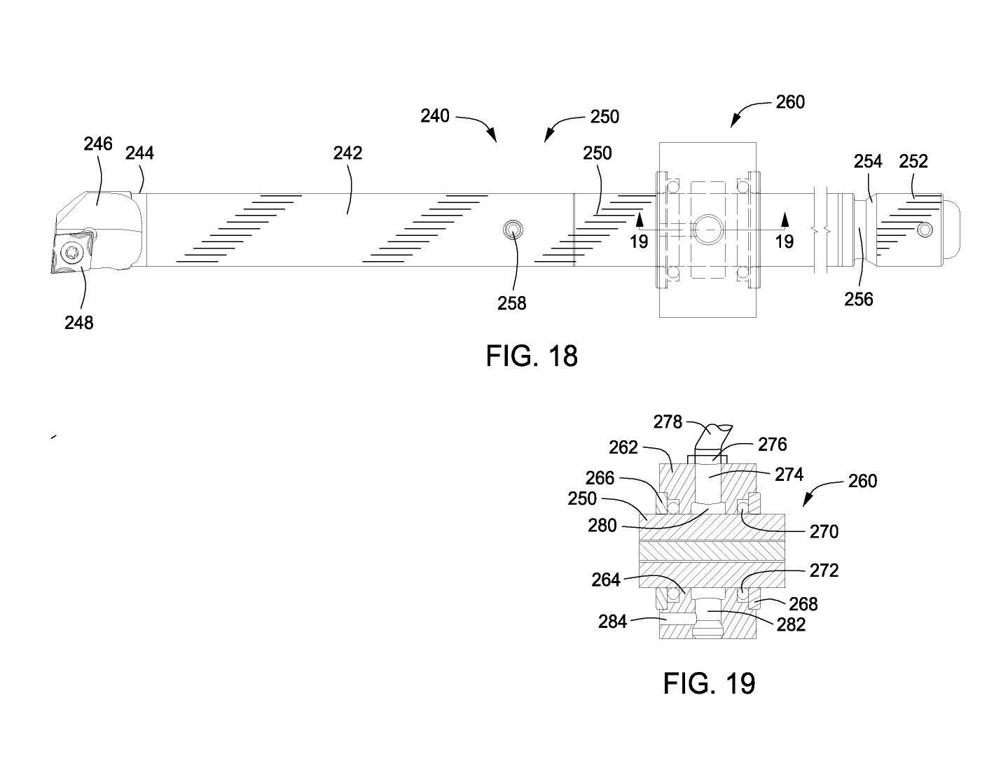

Though the anti-vibration tool holder is particularly intended to be provided with an internal coolant fluid supply system, with one or more jet fittings that direct coolant fluid onto the cutter element for cooling and cleaning during machining operations, it is to be borne in mind that an adjustable anti-vibration tool holder may be provided having an external coolant supply. As shown in FIGS. 18 and 19, an adjustable anti-vibration tool holder is shown generally at 240 having a tubular housing section 242 within which is contained an anti-vibration mechanism having an anti-vibration mass and resilient support members of the nature set forth in FIGS. 13 and 14. The tool holder 240 has a collar member 244 providing support for an insert support head 246 having a cutter seat on which is supported a replaceable cutter insert 248. The tool holder 240 is provided with an elongate tool shank 250 having a micrometer-type adjustment member 252 that is rotatably mounted to the rear or tool support end of the shank 250 for adjustment of the anti-vibration mechanism. The micrometer-type adjustment member 252 is provided with multiple indicia marks 254 and a reference mark 256 to enable precision adjustment of the anti-vibration mechanism. A set screw 258 may be tightened to secure the anti-vibration mechanism at any set position.

A coolant fluid supply mechanism, shown generally at 260, is releasably mounted to the elongate tool shank 250 of the tool holder 240 and has a coolant supply body 262 having an internal receptacle 264 within which the elongate tool shank is received. Retainer panels 266 and 268 are mounted to the coolant supply body 262 and cooperate with the coolant supply body to define seal receptacles within which seal members 270 and 272 are received for sealing the coolant supply body to the elongate tool shank. An internally threaded coolant inlet 274 is defined by the coolant supply body 262 and receives the coolant supply fitting 276 of a coolant supply conduit 278 of a machining system. The coolant supply body defines an annular internal recess 280 that conducts coolant fluid externally of the elongate tool shank 250 to a coolant distribution passage 282. A coolant jet passage 284 is in communication with the coolant distribution passage 282 and is oriented to direct a jet of coolant fluid onto the cutting edge of the replaceable cutter member 248.

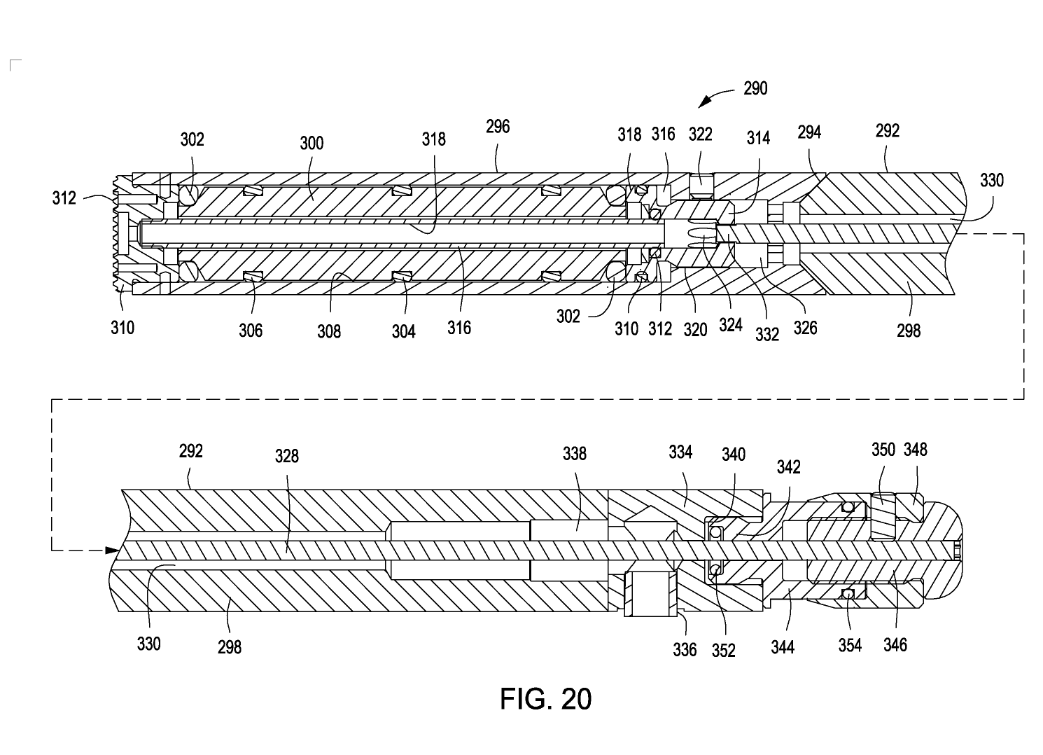

Referring to FIG. 20 an anti-vibration tool holder is shown generally at 290 has an elongate tool shank 292 having an intermediate tapered soldered or braised joint 294 that secures an anti-vibration housing 296 to a support section 298. Within an internal elongate compartment of the anti-vibration housing 296 is located an anti-vibration mass 300 having reduced diameter ends that are supported in centered relation within the internal elongate compartment by resilient dampening rings 302. A plurality of axially spaced external grooves 304 are formed in the anti-vibration mass 300 and each contain O-ring members 306 that engage the inner wall surface 308 of the anti-vibration housing 296 and assist the dampening rings in maintaining the external cylindrical surface of the anti-vibration mass 300 in spaced relation with the inner wall surface 308 of the tubular housing wall of the housing 296. A toolholder collar member 310 is mounted to the anti-vibration housing 296 and defines a grooved end 312 to which a through coolant cutter support head is mounted for machining operations as discussed above.

An anti-vibration tuning piston member 314 is positioned for movement within a piston chamber 316 and has a piston head 318 that is in engagement with one of the resilient dampening rings 302 and is sealed to the inner wall surface 308 by an annular seal member 310. A smaller diameter annular seal member 312 which is secured within a seal receptacle by a retainer ring establishes sealing of the tuning piston member 314 with a coolant tube 316 that extends through a central bore 318 of the anti-vibration mass 300. The tuning piston member 314 has a drive extension defining a cylindrical external surface 320 that is engaged by a set screw 322 when it is desired to lock the anti-vibration tuning piston against movement within the anti-vibration tool holder 290. The drive extension of the tuning piston defines a plurality of openings 324 through which coolant fluid flows from a piston chamber 326.

A tuning piston key rod 328 extends through a central passage 330 of the support section 298 of the tool holder mechanism 290 and defines an externally threaded piston drive end 332 that is engaged within an internally threaded opening of the anti-vibration tuning piston member 314. As the tuning piston key rod 328 is rotated this threaded engagement causes substantially linear tuning movement of the tuning piston member 314 causing the piston head 318 to move toward or away from the resilient dampening ring 302, depending on the direction of rotation of the tuning piston key rod 328.

The tool holder mechanism of the present invention is provided with a coolant entry and micrometer adjustment section 334 having a lateral coolant inlet fitting 336 to which a coolant supply line of a machining system is connected. The coolant entry section 334 is in communication with an internal coolant chamber 338 which supplies the central passage 330 with coolant fluid that flows externally of the tuning piston key rod 328. The coolant entry and micrometer adjustment section 334 defines an outwardly facing central recess 340 within which is received the central projection 342 of a micrometer body member 344. A micrometer head 346 and an external micrometer adjustment member 348 are rotatable relative to the micrometer body member 344 and are secured to the tuning piston key rod 328 by a set screw 350. O-ring seals 352 and 354 prevent the leakage of coolant fluid at the micrometer adjustment mechanism. As the micrometer adjustment member is rotated, the tuning piston key rod 328 is rotatably driven, with the threaded connection of the tuning piston key rod and the tuning piston causing linear movement of the anti-vibration tuning piston 314. The linear movement of the tuning piston adjusts the dampening force that is applied by the tuning piston to the anti-vibration mass 300 and permits vibration of the tool holder to be completely dampened. The set screw 322 can then be tightened to ensure maintenance of the tuning piston against inadvertent movement within the tool holder.

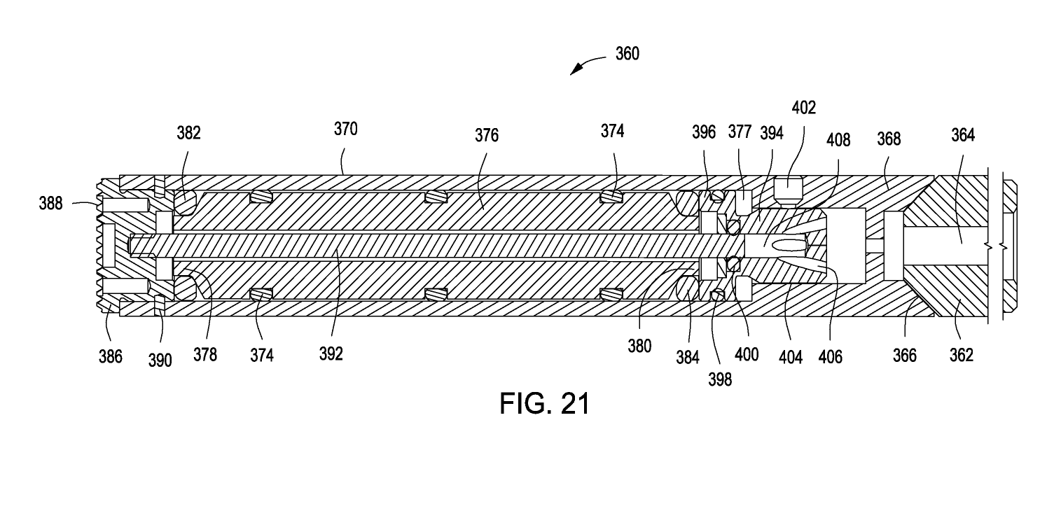

FIG. 21 shows an anti-vibration tool holder generally at 360 having a support and anti-vibration adjustment section 362 defining a coolant flow passage 364 and having silver soldered or braised connection at 366 with an anti-vibration housing section 368. The anti-vibration housing section 368 defines a tubular housing wall 370 having an inner cylindrical surface 372 that is engaged by a plurality of annular resilient members 374, such as resilient O-rings. These O-rings are contained within annular external grooves of an anti-vibration mass 376 that is supported within a chamber 377 that is defined by the tubular housing wall 370. The anti-vibration mass 376 has reduced diameter centrally located end projections 378 and 380 that are engaged and supported by annular dampening members 382 and 384 so that the anti-vibration mass is centrally positioned within the chamber 377, with its external surface spaced from the tubular housing wall 370. The annular resilient members 374 also assist in maintaining the anti-vibration mass in centrally located relation within the chamber 377.

A toolholder collar 386 having a grooved face 388 is fixed to the tubular housing wall 370 by dowel pins 390 and has the forward end portion of a coolant flow tube 392 connected centrally thereof. A vibration tuning piston member 394 has a head portion 396 carrying an annular seal member 398 that is in sealing engagement with the inner surface of the tubular housing wall and having an inner annular seal member 400 thereof in sealing engagement with the external surface of the shaft 392. A set screw 402 is threaded into the wall structure of the anti-vibration housing section 368 and serves to establish locking engagement with an external cylindrical surface 404 of the anti-vibration tuning piston 394 when it is desired to secure the tuning piston against movement within the anti-vibration housing. The anti-vibration tuning piston 394 defines a plurality of coolant fluid passages 406 that conduct coolant fluid flow to a central coolant passage 408 which is in communication with the coolant flow passage of the coolant tube 392.

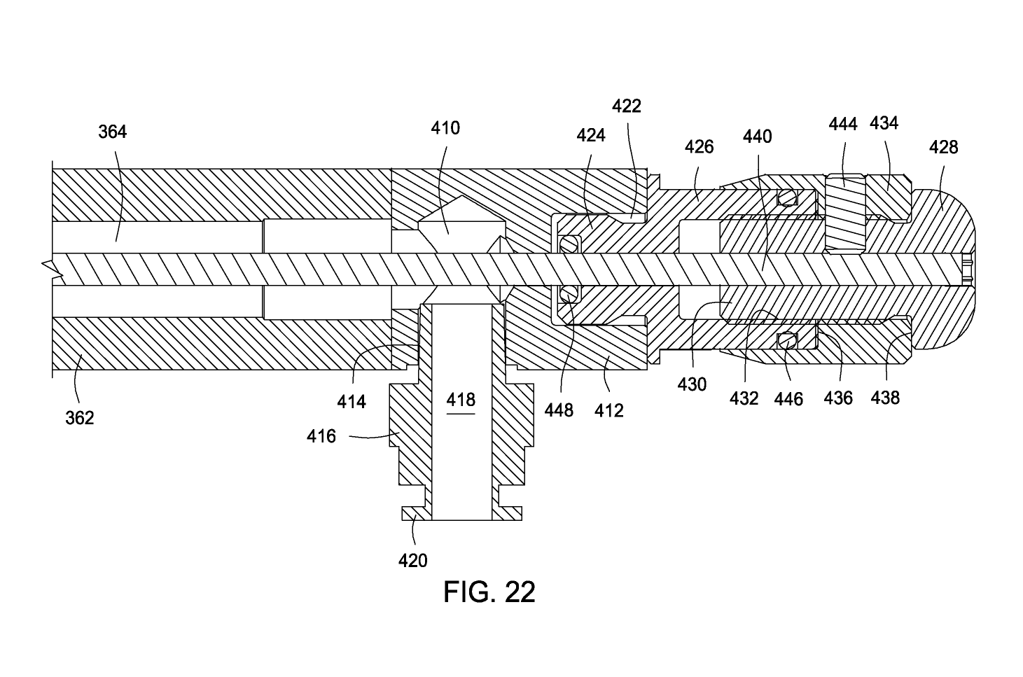

FIG. 22 illustrates the rear support and anti-vibration adjustment section of a tool holder such as may be connected with the anti-vibration tool holders 290 of FIG. 20 or 360 of FIG. 21. The support and anti-vibration adjustment section 362 defines a central longitudinal passage 364 which serves as a coolant flow passage that is in communication with a transverse coolant supply passage 410. The wall structure 412 of the support section defines a transversely oriented internally threaded opening 414 into which is threaded a coolant connector 416 having an internal coolant passage 418 and having a quick-disconnect coupling 420. The coolant supply conductor of a machining system is connected to the coupling 420 in order to provide the tool holder with a through coolant capability.

The support section also defines an axially oriented anti-vibration adjustment receptacle 422 within which is threaded an axial mounting projection 424 of an adjustment mount 426. A micrometer screw 428 has an externally threaded shaft 430 that is threaded into an internally threaded section 432 of the adjustment mount 426 and has a micrometer member 434 that is threaded to a portion of the externally threaded shaft 430. The micrometer member 434 is secured by an axially facing annular shoulder 436 of the adjustment mount 426 and an annular shoulder 438 that is defined by the head of the micrometer screw 428. The micrometer screw 428 defines an axially oriented passage 440 that serves as a rod receptacle within which the rear end portion of a tuning piston key rod 442 is secured by a set screw 444.

When the micrometer screw 428 and the micrometer member 434 are manually rotated, the tuning piston key rod 442 is also rotated and accomplishes vibration dampening or tuning movement of the vibration tuning piston member 394 as described above in connection with FIG. 21. To minimize the potential for coolant leakage at the micrometer adjustment mechanism an annular resilient seal member 446 is contained within an annular seal groove of the adjustment mount 426 and has sealing engagement with an internal cylindrical sealing surface of the micrometer member 434. An annular resilient seal member 448 is contained within an annular seal recess of the axial mounting projection 424 and has sealing engagement with the tuning piston key rod 442.

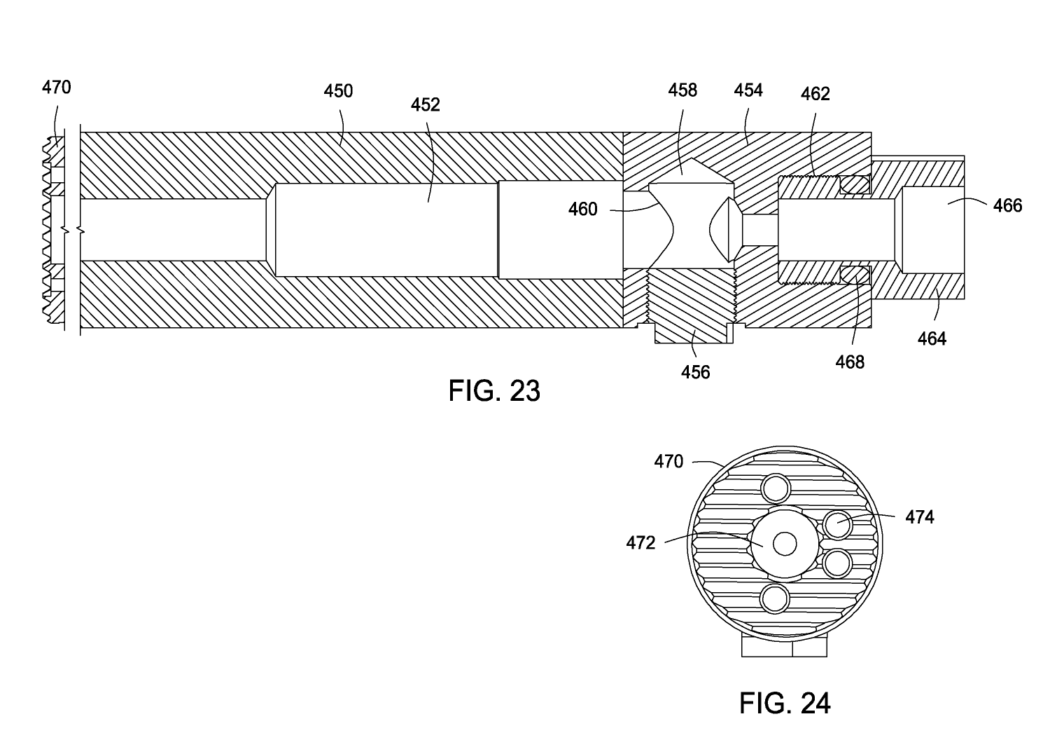

With reference to FIGS. 23 and 24 there is shown a coolant fluid handling system for a tool holder mechanism having a vibration tuning mechanism that is shown by other figures, such as FIGS. 20-22. The coolant fluid handling system provides the user with alternatives for connection of a coolant fluid supply line to the tool holder. The tool holder body 450 defines an axially oriented coolant passage 452 and has a coolant fluid coupling section 454. An externally threaded plug member 456 is threaded into an internally threaded section of a transversely oriented coolant inlet passage 458. The plug member 456 has an intermediate configuration 460 that defines a flow passage past the plug member. If desired, the plug member may be removed from the internally threaded opening and a coolant inlet fitting, such as is shown in FIGS. 20, 22 and 25 may be threaded in its place. The coolant fluid coupling section 454 defines an axially oriented receptacle 462 within which is received an end portion of a vibration tuning adjustment mount 464. The adjustment mount defines an internal passage 466 through which a vibration tuning adjustment rod or shaft extends such as shown in FIG. 20. To prevent coolant leakage at the adjustment mount an annular resilient seal member 468 is captured within an annular seal groove and has sealing engagement with the inner cylindrical surface of the axially oriented receptacle 462. A tool holder collar 470 is shown in FIGS. 23 and 24 and defines a mounting face having grooves and ridges as described above and having a coolant recess 472 and openings 474 for controlling coolant jet flow to a metal cutting insert as described above.

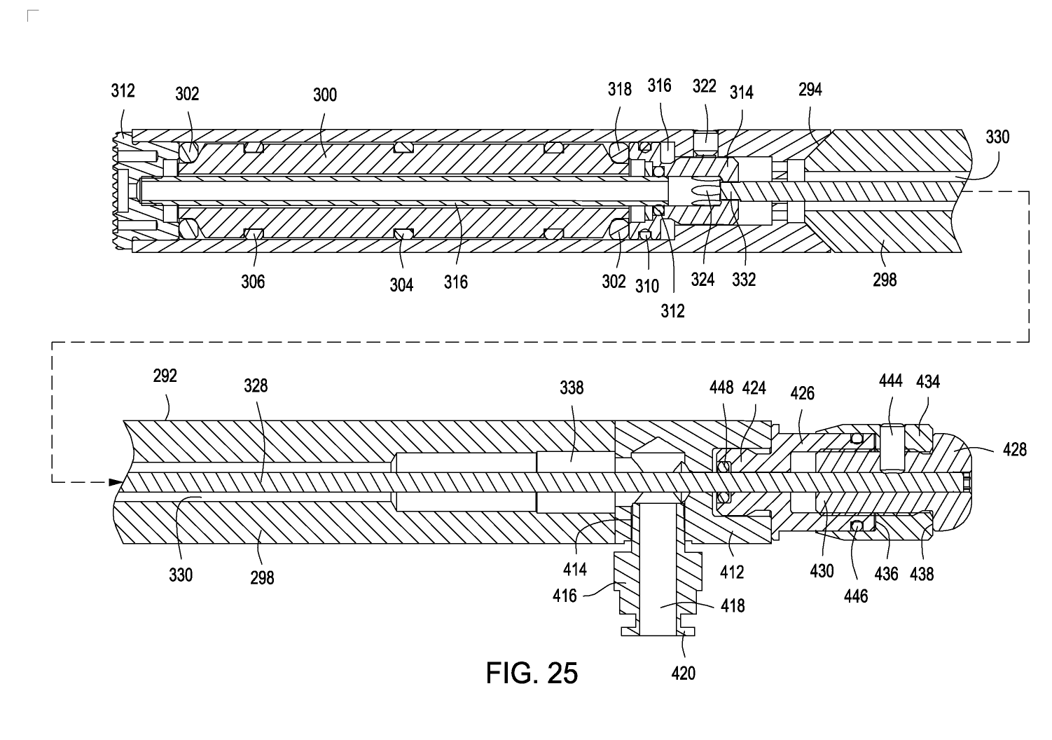

Referring to FIG. 25 a mass dampened tool holder is shown which incorporates features that are shown in FIG. 20 and described above and features that are shown in FIGS. 22 and 23 and also described above. Corresponding reference numerals in FIGS. 20, 22 and 23 are incorporated for like components within FIG. 25.

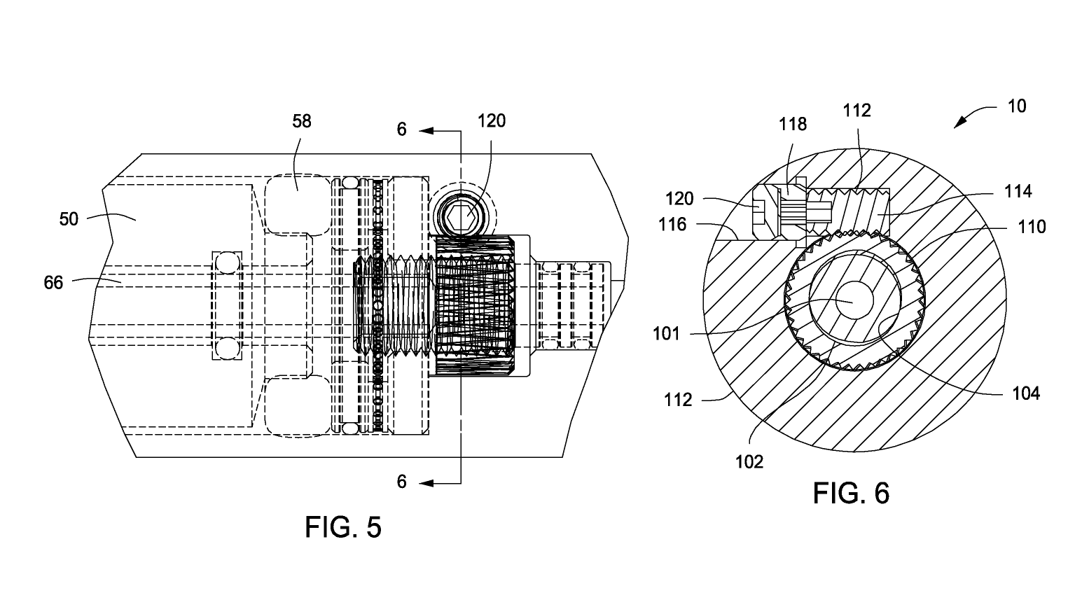

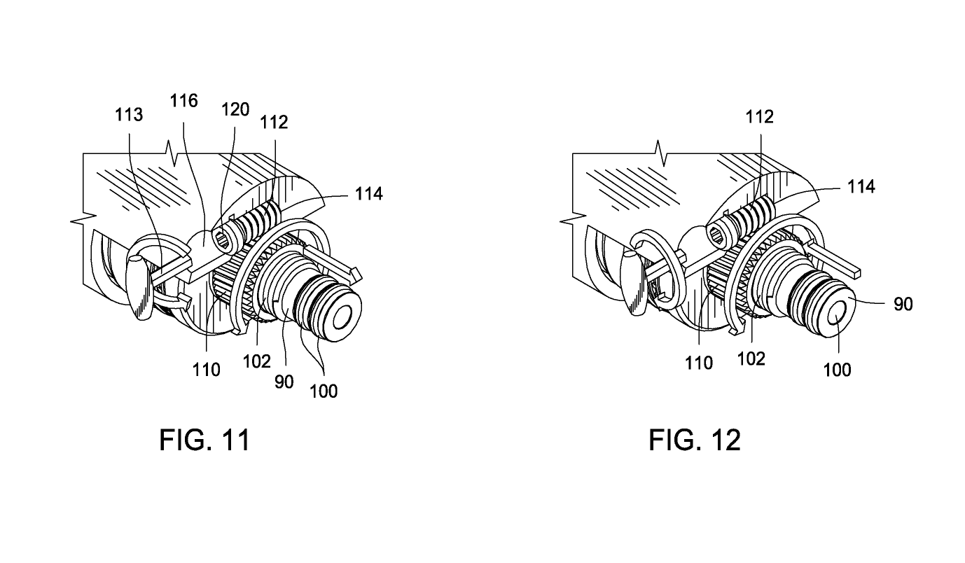

Operation: With reference to FIGS. 1-13, a machine tool holder constructed according to the principles of the present invention is mounted to a machining mechanism, such as by employing a chuck device and a work-piece to be machined is mounted for rotation at a proper rotary speed for efficient machining of the work-piece. In the event vibration of the machine tool holder should become evident either by the annoying sound of machining activity or by the rough or uneven appearance of the machined surface being formed, or both, the machining process will be stopped. The machine operator will then insert a worm drive key 113 having a non-circular drive configuration, such as the hex configuration of an Allen wrench into the worm drive receptacle 120 and will rotate the worm member 114 in a selected direction of rotation, either driving the force transmitting member 106 toward the anti-vibration mass 50 or away from it. When the machining sound and the machining quality improve, the direction of anti-chatter adjustment that has been chosen by the machine operator will be confirmed. If, during a machining operation, due to a change of temperature or due to the presence of any of a number of machining detriments, the sound and appearance indicate the presence of excessive machine tool vibration, the machining process can again be stopped, and the machinist can easily achieve fine tuning adjustment of the vibration dampening mechanism by selective rotation of the worm member to restore the precision character of the machining process. Anti-vibration tuning of a tool holder, such as a boring bar, can be done each time a cutter insert is changed out and several times during an extended machining process until the service life of the cutter insert has been used.

During machining operations, coolant fluid is pumped to the machine tool and through internal coolant passages of the machine tool and the anti-vibration mass and caused to be emitted as a jet of coolant from a jet port of the cutter support head to the cutting interface of the cutter insert member and the work-piece being machined.

With reference to FIGS. 14-25 the anti-vibration tool holder, as indicated above, incorporates an anti-vibration mass adjustment mechanism in the form of a micrometer adjustment that is mounted to the rear or supported end portion of the boring bar or other tool holder device. The micrometer type rotary adjustment member 428 is manually rotatable about the longitudinal axis of the tool holder body and causes rotation of the tuning piston key rod 328. The tuning piston key rod actuates a tuning piston drive mechanism that achieves actuation of a force transmitting tuning piston member 156 that engages and transmits force to a resilient support member 136. The resilient support member is in supporting and force transmitting engagement with an anti-vibration mass 132 that is encapsulated in supported and centralized relation within the intermediate tubular section of the tool housing 124. For adjustment of the anti-vibration mechanism of the tool holder the micrometer adjustment mechanism is manually rotated, typically to the right, causing threaded head portion 332 of the hex key rod or shaft to be rotated within the internally threaded portion of the tuning piston member 314. External threads of the hex key rod react with internal threads of the force transmitting tuning piston member 156. This activity causes the tuning piston member to be driven linearly, thus changing the force being applied by the tuning piston 314 to the resilient dampening ring 302 and from the dampening ring to the vibration dampening mass. This activity adjusts the position of the vibration dampening mass within its chamber, thus adjusting the vibration frequency of the tool holder. Typically, the tuning piston member is adjusted until the frequency of vibration of the tool holder is under 25 per m/s. At that the tuning piston is locked in place by means of a set screw or other suitable retainer device.

Preferably coolant fluid is caused to flow through the tool holder as shown in FIGS. 16 and 17 to direct a jet of coolant fluid onto the cutting edge 46 of the machining insert 36. Alternatively, however, the tool holder may not incorporate an internal coolant system or may have an external coolant fluid supply system without departing from the spirit and scope of the present invention. The machine operator will therefore initiate machining of a part and, if machining chatter is present to any degree, the operator will simply rotate the micrometer type adjustment member 216-226, accomplishing rotation of an adjustment shaft or wrench 222 for accomplishing linear movement of the force transmitting member as necessary to cause dampening of the machining chatter.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A method for selectively adjusting a cutter supporting machine tool for vibration dampened rotary machining activity the machine tool having a tool body containing a vibration dampening mass being supported within a chamber of said machine tool body by resilient dampening members, said machine tool body supporting a cutter head having a replaceable cutter insert mounted thereto for cutting engagement with a work-piece being rotated by said machining system, the tool body having therein a linearly moveable force transmitting member and a vibration dampening adjustment drive mechanism selectively moving said force transmitting member in desired linear directions, said method comprising:
determining vibration characteristics of said machine tool body during rotary machining activity;
rotating a vibration dampening adjustment member of said machine tool body in a selected rotary direction for adjusting force transmission to said vibration dampening mass and its resilient supports; and
moving a force transmitting member linearly by force of said anti-vibration drive member in a selected direction relative to said elastomeric dampening members and said anti-vibration mass sufficiently to substantially cancel the resonant frequency of machining vibration.

2. The method of claim 1 wherein a vibration dampening adjustment mechanism is a micrometer mechanism being rotatably mounted to said machine tool body and having a drive member rotated within said machine tool body by rotation of said micrometer mechanism, the drive member having an end portion in linear driving engagement with the linear force transmitting member

3. The method of claim 1, wherein a worm gear actuated drive member is positioned for rotation within a worm gear passage of said elongate machine tool body and defines a first worm gear and said force transmitting member being rotatably moveable within said elongate machine tool body and defines a second worm gear having driven engagement with said first worm gear, said force transmitting member having an internal thread in threaded engagement with an external thread of a non-rotatable drive member, said method comprising:
rotating said force transmitting member by rotation of said first worm gear in engagement with said second worm gear; and
during said rotating said force transmitting member causing linear movement of said force transmitting member by engagement of said internal threads of said force transmitting member with said external threads of said non-rotatable drive member.

4. The method of claim 3, wherein a slip disc member is positioned within said machine tool body and in engagement with one of said elastomeric dampening members and a thrust bearing member is interposed between said force transmitting member and said slip disc member, said method comprising:
rotating and moving said force transmitting member against said thrust bearing member, and
with said force transmitting member and said thrust bearing member moving said slip disc member linearly and non-rotatably relative to said one of said elastomeric dampening members causing said substantial cancellation of the resonant frequency of vibration of said elongate machine tool body during machining.

5. The method of claim 1, wherein a force transmitting member is located within said elongate machine tool body and a micrometer type rotary anti-vibration adjustment member is located at an end of said elongate machine tool body in driving relation with said force transmitting member, said method comprising:
rotating said micrometer type rotary anti-vibration adjustment member in a selected rotary direction for adjusting application of force of said force transmitting member to said anti-vibration mass and said elastomeric dampening members and causing substantial cancellation of the resonant frequency of vibration of said elongate machine tool body during machining.

6. The method of claim 1, comprising:
conducting coolant fluid flow through said elongate machine tool body and said anti-vibration mass during machining operations; and
applying a jet of coolant fluid to the cutting edge of a cutter insert during machining.

7. The method of claim 1, comprising:
from a machine pump coolant fluid supply mounted externally of said elongate machine tool body directing a jet of coolant fluid onto the cutting edge of a machining insert that is supported by said elongate machine tool body.

8. An adjustable vibration dampening tool holder for a machining system, comprising:
a tool body having a supported end portion for support by a machining system and having a cutter support head and walls defining an internal vibration dampening cavity;
a vibration dampening mass being located within said vibration dampening cavity;
resilient dampening members being located in longitudinally spaced relation within said internal vibration dampening cavity and supporting said vibration dampening mass for movement within said internal vibration dampening cavity;
a force transmitting member being moveable within said internal tool body and being disposed for application of position adjustment force to said vibration dampening mass within said internal vibration dampening cavity; and
a vibration frequency adjustment mechanism having a first adjustment member rotatably mounted to said tool body and a second adjustment member translating rotary motion of said first adjustment member to linear movement of said force transmitting member, said vibration frequency adjustment mechanism imparting linear adjustment force to said force transmitting member and said vibration dampening mass.

9. The adjustable vibration dampening tool holder of claim 8, comprising:
said tool body having an internal passage extending from said internal vibration dampening cavity to said supported end portion; and
an elongate adjustment key extending from said first adjustment member through said internal passage and having linear driving vibration frequency adjusting engagement with said force transmitting member, whereby selective rotation of said first adjustment member causing linear dampening adjustment movement of said force transmitting member and said vibration dampening mass.

10. The adjustable vibration dampening tool holder of claim 9, comprising:
said force transmitting member having an internal thread;
said elongate adjustment key having an external thread in threaded engagement with said internal thread; and
upon rotation of said first adjustment member said elongate adjustment key being rotated and said internal and external threads causing linear force adjusting movement of said force transmitting member for controlled absorption of machining induced vibration of said machine tool body.

11. The adjustable vibration dampening tool holder of claim 8, comprising:
a coolant flow passage being defined within said tool holder and receiving pressurized coolant fluid from a coolant supply of the machining system and delivering the pressurized coolant fluid to a cutter being supported by said cutter support head; and
a coolant fluid coupling being mounted to said tool body in fluid communication with said coolant flow passage and receiving coolant fluid flow from a coolant supply conductor of the machining system.

12. The adjustable vibration dampening tool holder of claim 8, comprising:
a coolant fluid device mounted externally of said machine tool body and having an internal coolant fluid passage and a coolant jet orifice in communication with said internal coolant passage and being oriented to direct a jet of coolant fluid to the cutting interface of a machining insert and a work-piece being machined; and
a coolant supply connector coupling being mounted to said coolant fluid device and having connection with a coolant fluid supply conductor of a machining system.

13. The adjustable vibration dampening tool holder of claim 8, comprising:
said machine tool body having a longitudinal axis;
said first adjustment member being a first worm gear rotatably supported by said machine tool body and having an axis of rotation oriented in transverse relation with said longitudinal axis; and
said second adjustment member being a second worm gear engaged in driven relation with said first worm gear and being moved linearly in response to rotary movement of said first worm gear, said second worm gear being defined by said force transmitting member.

14. The adjustable vibration dampening tool holder of claim 13, comprising:
a force transmitting surface being defined by said force transmitting member;
a bearing member having force transmitting engagement with said force transmitting surface; and
a disc member having force transmitting engagement with said bearing member and having engagement with a resilient dampening member for application of dampened adjustment force to said vibration dampening mass.

15. An adjustable vibration dampening tool holder for a machining system, comprising:
An elongate tool body having a supported end portion for support by a machining system and having a cutter support head and walls defining an internal vibration dampening cavity, said elongate tool body defining an internal passage extending from said internal vibration dampening cavity to said supported end portion of said elongate tool body;
a vibration dampening mass being located within said vibration dampening cavity;
resilient vibration dampening members being located in longitudinally spaced relation within said internal vibration dampening cavity and supporting said vibration dampening mass for vibration dampening movement within said internal vibration dampening cavity;
a force transmitting member being moveable within said internal tool body and having engagement with a vibration dampening member and applying of position adjustment force to a vibration dampening member and to said vibration dampening mass within said internal vibration dampening cavity; and
a vibration frequency adjustment mechanism having a first adjustment member rotatably mounted to said tool body and a second adjustment member in driven relation with said first adjustment member and translating rotary motion of said first adjustment member to linear movement of said force transmitting member, said vibration frequency adjustment mechanism imparting linear adjustment force to said force transmitting member and said vibration dampening mass.

16. The adjustable vibration dampening tool holder of claim 15, comprising:
said tool body having an internal passage extending from said internal vibration dampening cavity to said supported end portion;
an elongate adjustment key extending from said first adjustment member through said internal passage and having linear driving vibration frequency adjusting engagement with said force transmitting member, whereby selective rotation of said first adjustment member causing linear dampening adjustment movement of said force transmitting member and said vibration dampening mass;
said force transmitting member having an internal thread;
said elongate adjustment key having an external thread in threaded engagement with said internal thread; and
upon rotation of said first adjustment member said elongate adjustment key being rotated and said internal and external threads causing linear force adjusting movement of said force transmitting member for controlled absorption of machining induced vibration of said machine tool body.

17. The adjustable vibration dampening tool holder of claim 15, comprising:
said machine tool body having a longitudinal axis;
said first adjustment member being a first worm gear rotatably supported by said machine tool body and having an axis of rotation oriented in transverse relation with said longitudinal axis; and
said second adjustment member being a second worm gear engaged in driven relation with said first worm gear and being moved linearly in response to rotary movement of said first worm gear, said second worm gear being defined by said force transmitting member.

18. The adjustable vibration dampening tool holder of claim 17, comprising:
a force transmitting surface being defined by said force transmitting member;
a bearing member having force transmitting engagement with said force transmitting surface; and
a disc member having force transmitting engagement with said bearing member and having engagement with a resilient dampening member for application of dampened adjustment force to said vibration dampening mass.

19. The adjustable vibration dampening tool holder of claim 15, comprising:
a coolant fluid device mounted externally of said machine tool body and having an internal coolant fluid passage and a coolant jet orifice in communication with said internal coolant passage and being oriented to direct a jet of coolant fluid to the cutting interface of a machining insert and a work-piece being machined; and
a coolant supply connector coupling being mounted to said coolant fluid device and having connection with a coolant fluid supply conductor of a machining system.
